(19) United States
(12) Patent Application Publication
(10) Pub. No.: US 2016/0364426 A1
(43) Pub. Date: Dec. 15, 2016

(54) MAINTENANCE OF TAGS ASSIGNED TO ARTIFACTS

(71) Applicant: SAP SE, Walldorf (DE)

(72) Inventors: Sebastian Schroetel, Walldorf (DE); Uwe Schulz, Walldorf (DE); Udo Klein, Walldorf (DE)

(21) Appl. No.: 14/736,985

(22) Filed: Jun. 11, 2015

(51) Int. Cl. G06F 17/30

(52) U.S. Cl. CPC G06F 17/30342; G06F 17/30377

(57) ABSTRACT

An artifact in an application is assigned with a tag. The tag is a string that characterizes the artifact. A list of suggested tags is provided, which includes tags assigned to similar artifacts maintained by the application. The list of suggested tags also includes newly suggested tags based on analysis of the artifact. The tags within the application are maintained and operations such as deletion, renaming, or unification of tags are performed. Unification of tags is performed through determining similarities between at least two tags. The similarity is determined based on existence of a trigram in the at least two tags after normalization of tags and based on edit distance between each two tags from the at least two tags. A tag cloud is provided for navigation between artifacts in the application. Tag cloud is defined based on frequency of use and selectiveness of tags.

### BACKGROUND

Software applications may store object that include content, such as different documents, articles, tasks, etc. Such objects may be tagged with data strings to point out to specific characteristics of the objects. For example, an article discussing current trends in car manufacturing may be tagged with a keyword such as the string “car”, or “manufacturing”, or even “car manufacturing”. In such manger, the object may be distinguished from the other objects, which may discuss manufacturing related to other products, such as aircraft, household appliances, etc. There are different types of software application that may utilize tags for their content. A tag represents additional criterion for identifying a particular object, and several tags may be assigned to an object. Tags may be non-hierarchical keywords or terms that may be assigned to a piece of information, such as a bookmark, an image, a file, a folder, etc. This helps describe an item and helps with browsing and/or searching. Tags may be depicted and visualized into a tag cloud, which is a visual representation of text data.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an exemplary environment for maintaining tags to characterize artifacts, according to one embodiment.

FIG. 2A is a flow diagram illustrating a process for defining, assigning, and maintaining tags related to artifacts, according to one embodiment.

FIG. 2B is a flow diagram illustrating a process for navigation in an application based on existing tags assigned to artifacts, according to one embodiment.

FIG. 2C is a flow diagram illustrating a process for administering tag assignments to artifacts in an application, according to one embodiment.

FIG. 3 is a block diagram illustrating an exemplary user interface for presenting objects that are structured through tags in an innovation management system, according to one embodiment.

FIG. 4A is a flow diagram illustrating a process for assigning tags to artifacts, according to one embodiment.

FIG. 4B is a flow diagram illustrating a process for maintaining existing tags assigned to artifacts, according to one embodiment.

FIG. 4C is a block diagram illustrating exemplary schemas for deleting an existing tag assigned to artifacts, according to an embodiment.

FIG. 4D is a block diagram illustrating exemplary schemas for unifying a set of existing tag assigned to artifacts, according to an embodiment.

FIG. 5 is a flow diagram illustrating a process for generating a list of suggested tags for assigning to an artifact, according to one embodiment.

FIG. 6A is a flow diagram illustrating a process for navigation between artifacts through a tag cloud, according to one embodiment.

FIG. 6B is a flow diagram illustrating a process for computing a tag cloud based on existing tags assigned to artifacts in an application, according to one embodiment.

FIG. 7 is a block diagram illustrating an embodiment of a computing environment in which the techniques described for maintaining tags to characterize artifacts can be implemented.

### DETAILED DESCRIPTION

Embodiments of techniques for maintaining tags assigned to artifacts are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

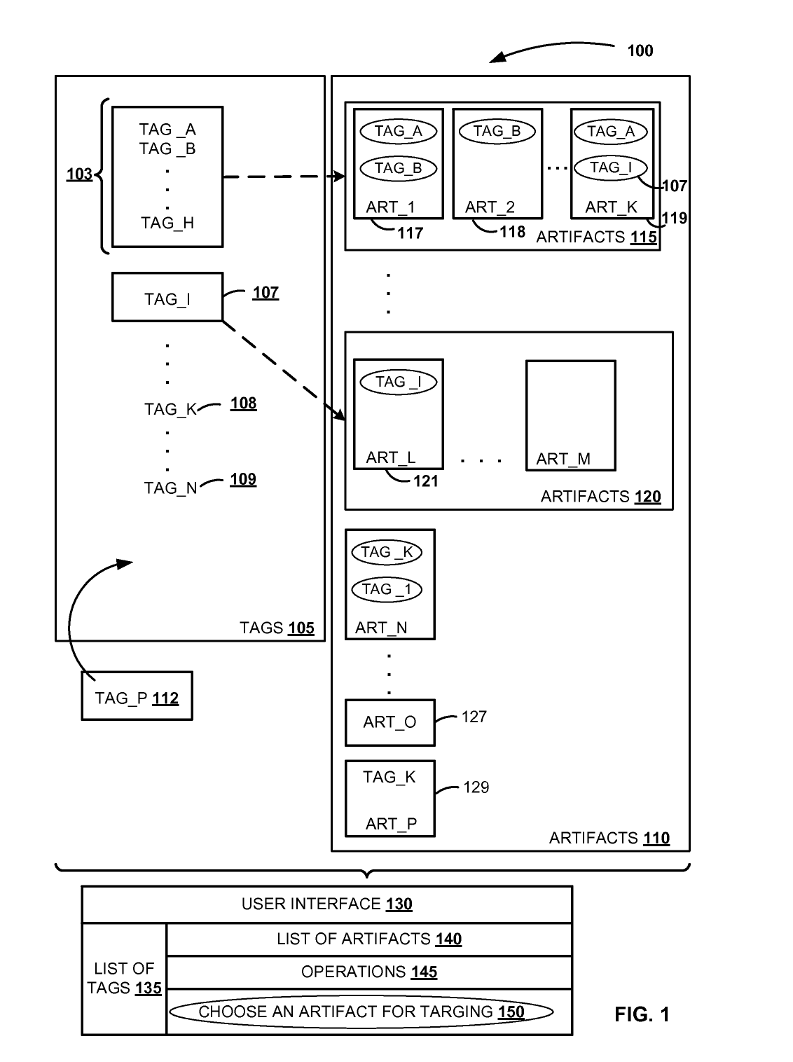

FIG. 1 is a block diagram illustrating an exemplary environment 100 for maintaining tags 105 to characterize artifacts 110, according to one embodiment. The artifacts 110 comprise sets of artifacts such as, set_of_artifacts 115 through set_of_artifacts 120, and single artifacts—artifact_N 125, through artifact_O 127, until artifact_P 129. The artifacts from set_of_artifacts 115 through set_of_artifacts 120 may be organized into sets according to a common characteristic that they share. For example, if the artifacts are articles in a web magazine, a set of artifacts may be a set of articles provided by a common author, or a set of articles that are part of a common category, such as architecture, lifestyle, news, etc. An artifact from the artifacts 110 may be tagged with one or more tags that may add an additional criterion characterizing the artifact. A tag from the tags 105 may be particularly defined for an artifact or a set of artifacts. The allocation and definition of tags to be connected with an artifact or a set of artifacts may be predetermined in a system that maintains the artifacts 110 and the tags 105.

In one embodiment, the set_of_artifacts 115 share a common characteristic and may be tagged with a set of tags 103, including tag_A, tag_B, until tag_H. For example, the set_of_artifacts 115 may be a set of articles regarding fashion, and tag_A may be “fashion”, tag_B may be “hairstyling”, tag_H may be “make-up”. The set_of_artifacts 115 may include artifacts art_1 117, art_2 118, until art_k 119. The art_1 117 is tagged with the tag_A, and the tag_B, the art_2 118 is tagged with the tag_B. The art_K 119 is tagged with the tag_A, which is part of the set of tags 103, which is particularly defined for the set_of_artifacts 115. The art_K 119 is further tagged with tag_I 107, which is not included in the set of tags 103. Further, the tag_I 107 may be defined as a tag associated with the set_of_artifacts 120. The art_L 121 is tagged with the tag_I 107. If a new artifact is about to be included in the artifacts 110, for example, in the set_of_artifacts 115, a tag from the tags 103 connected with the set_of_artifacts 115, may be suggested for the new artifact. However, the new artifact may not be assignED with a tag from the suggested tags associated with the set 115, and another tag may be determined for assigning.

In one embodiment, a tag_P 112 may be included in the tags 105 and the tag_P 112 may be associated with a particular set of artifacts, for example, based on a semantic correspondence between the string representing the tag_P 112 and a common characteristic that the content of artifacts from the set of artifacts share.

The artifacts 110 and the tags 105 may be stored and maintained by a software application that may have a user interface (UI) 130 that displays a list of tags 135 that is generated on the basis of the maintained tags 105. The UI 130 may further present a list of artifacts 140 generated based on the artifacts 110. The presented list of tags 135 and the presented list of artifacts 140 may be defined on a criterion for selection for presentation, such as limiting to a particular number of objects, or based on priority or other ranking, date and time, alphabetical order, etc. The UI 130 may further provide an “operations” 145 section to select an operation to be performed in relation to the artifacts 110 and the tags 105. For example, “choose an artifact for tagging” operation 150 may be provided through the UI 130. With the operation 150, an artifact from the list of artifacts 140 may be selected, and a tag from the tags 105 may be suggested for tagging the selected artifact. In another embodiment, other operations may be provided in the “operations” 145 section—defining a new tag to be included in the tags 105, filtering the list of artifacts 140 through selecting a tag from the list of tags 135 to generate a filtered list of artifacts that are assigned with the selected tag, etc.

In one embodiment, the software application that maintains artifacts and tags may be an innovation management system that utilizes tags as a central structuring element. The innovation management system targets different stages of the lifecycle of innovation management. The lifecycle includes steps such as generation of ideas, their submission into campaigns, their discussion and collaborative work in communities, their evaluation by expert groups, the portfolio process of innovation projects, inclusion of ideas into products, up to successful market introduction of the products. The innovation management system may contain ideas, campaigns, users, and other artifacts. There can be a huge number of artifacts, which is difficult to be maintained and to be browsed. In order for a user working with the innovation management system to be able to select groups of ideas, ideas and/or other artifacts, the artifacts may be tagged. Such a tag can be used to find easily all information associated with the artifacts that have the respective descriptive tag assigned.

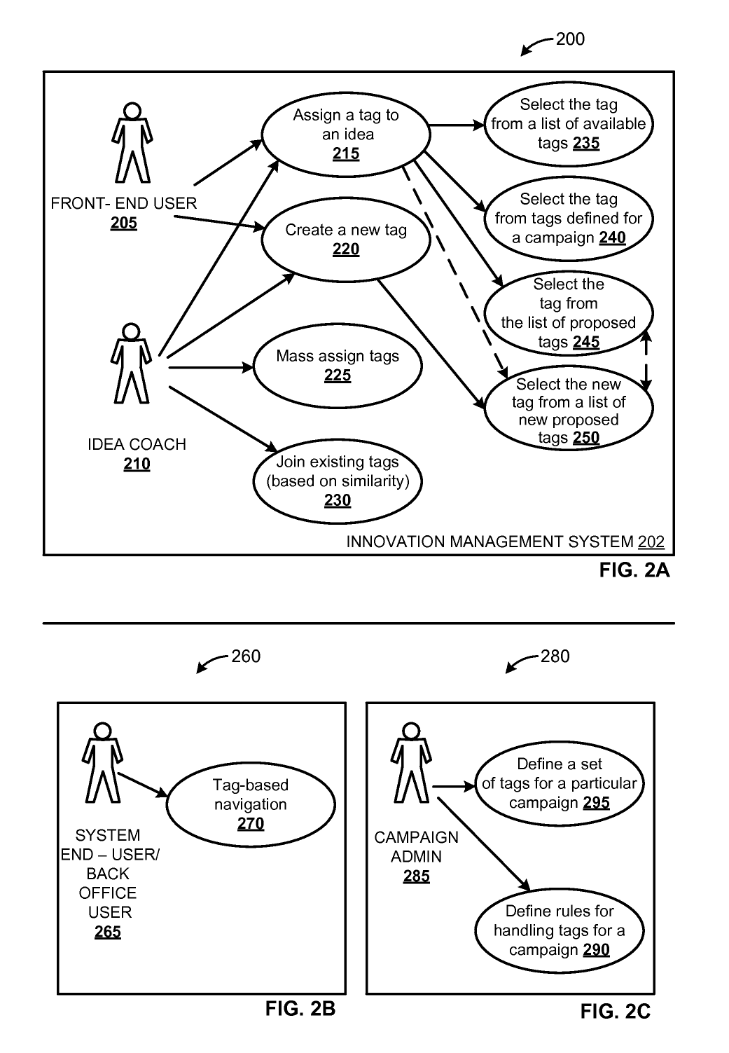

FIG. 2A is a flow diagram illustrating a process 200 for defining, assigning, and maintaining tags related to artifacts, according to one embodiment. For example, the artifacts may be maintained in an innovation management system 202. The innovation management system 202 may include artifacts such as ideas, which may be grouped in campaigns that may be separate artifacts. The artifacts in the innovation management system 202 may be entered, for example, by a front-end user of the system 202, by an idea coach 210, by an administrator of the system 202, or automatically be transferred from another system.

In the innovation management system 202 there may be a huge number of ideas and also many campaigns providing information in an unstructured manner. Having the information structured makes it more useful when working with the innovation management system 202. Structuring is also useful during searching for relevant information and respectively for relevant artifacts. Through utilizing tags and tag assignment options provided by the innovation management system 202, all information (ideas, campaigns, etc.) may be found easily through searching relevant tags and navigating between artifacts that are associated with the relevant tags. A tag may be a string that is assigned to an idea. The tag represents an additional criterion for distinguishing the artifact from rest of the artifacts in the innovation management system 202. A tag may be used to identify and group ideas and/or other artifacts. An idea or other artifact may have several tags. A single tag may be assigned to several artifacts. A tag may comprise one or more words. The words may be defined with normal characters as well as numbers and special characters. There may be some restrictions in syntaxes used for defining tags. For example, a tag may be restricted to comprising characters such as “,” or “;”. In addition, if a tag is defined with leading and training whitespace, they may be removed from the tags during the process of defining the tags in the innovation management system 202.

In one embodiment, the innovation management system 202 may have a set of users registered and authorized to work with the system 202. The innovation management system 202 may classify a user as a separate artifact. Tags may be assigned to existing artifacts or during artifacts' creation process in the innovation management system 202. The front-end user 205 may interact with the innovation management system 202, for example through a UI of a front-end office of the innovation management system 202. The front-end user 205 may be, for example, an idea submitter. The idea coach 210 may interact with the innovation management system 202, for example, through a UI of a back-end office of the innovation management system 202. Specialists working professionally with ideas and campaigns may use the back-end office. Examples of back-office users apart from the idea coach 210 may be a campaign manager or a campaign administrator, an innovation manager, etc. For example, the idea coach 210 may process the ideas of a given campaign, set up in the innovation management system 202. Idea coaches may be authorized to process and evaluate ideas in the back-end office of the innovation management system 202. The idea coaches may assign themselves or other idea coaches to ideas. In one embodiment, users that have been previously assigned as idea coaches to a campaign are the only users that may be assigned as an idea coach to an idea part of the campaign. Further, campaign managers may set up and monitor campaigns; innovation managers may administer users, configure phases and evaluation methods for campaigns, etc.

In one embodiment, at use case 215, the front-end user 205 or the idea coach 210 may assign a tag to an idea. The assignment of tags may be performed through either the front-end office UI of the innovation management system 202 or the back-end office UI of the innovation management system 202 that comprises artifacts, such as ideas, campaigns, user, etc. The assigning of tags as suggested at 215 may be limited to only a part of the front-end users that are authors or coauthors of the particular artifacts that is tagged, e.g. the idea. In one embodiment, the assigning of the tag at use case 215 may be performed at 235 through selecting the tag from a list of available tags in the innovation management system 202. The list of available tags may be such as the tags 105, FIG. 1. The innovation management system 202 may provide a function for central definition of tags. With such a function, the list of available tags that may be suggested at 235 may be pre-filled. In yet another embodiment, at 240, the tag may be selected from tags that are particularly defined as associated with a campaign that comprises the idea. Referring back to FIG. 1, a campaign may be a set of artifacts such as set_of_artifacts 115, FIG. 1, and the tags that may be proposed as a suggestion for tagging at 240 may be the set of tags 103, FIG. 1.

In another embodiment, when assigning the tag at 215, the tag may be selected at 245 from a list of proposed tags that are not currently stored in the innovation management system 202. For example, the list of new proposed tags may be generated based on encountered keywords in the selected idea for tagging at 215. Further, the list of proposed tags that is suggested at 245 may be generated based on a text analysis over the content of the idea, e.g. idea's title, idea's description, idea's attachments, etc. The list of proposed tags may further include tags that are defined through a similarity search performed over the idea selected for tagging and rest of the ideas handled by the innovation management system 202. A similarity search function may be provided by the innovation management system 202 to compute a similarity between the selected idea at 215 and the rest of the ideas in the innovation management system 202. Based on the computed similarity, a list of tags assigned to similar ideas may be provided. For example, the list of tags of similar ideas may be ranked and tags coming from more similar ideas may come first in the list. The similarity search function relies on the existing tags assigned to ideas in the innovation management system 202 to provide tag suggestions. The innovation management system 202 may provide and display a list of similar tags, together with information about their usage and a degree of similarity between the each couple of similar tags. The described examples herein are not limiting the way a list of proposed tags is generated and are only presented for illustration purposes. Further, tag assignment may be performed in a similar manner to other artifacts apart from ideas (campaigns, users, etc.) in the innovation management system 202.

At use case 220, the front-end user 205 or the idea coach 210 may create a new tag 220. The new tag 220 may be entered in the innovation management system 202, for example, in a storage or a database, where other maintained tags are stored. When creating the new tag at 220, a list of new proposed tags may be suggested at 250 for selection, for example, by the front-end user 205. The list of new proposed tags may be the one that is suggested when the tag is assigned to the idea at 215. The list of new proposed tags may be suggested when the list of proposed tags is suggested at 245. In one embodiment, at 220, the new tag is created and then it may be used for assigning to artifacts. In another embodiment, with the initiation for assigning a tag to an idea at 215, a new tag may be created and assigned simultaneously. The newly created tag at 220 may be assigned to an idea in a corresponding manner to the assignment of a tag to an idea as suggested in the use case 215, where the newly created idea at 220 may be part of the list of available tags suggested at 235.

In one embodiment, the idea coach 210 may assign tags simultaneously to a number of artifacts from the innovation management system 202 at use case 225, which means that mass assigning of tags to artifacts, such as ideas, is performed. The idea coach 210 at 230 may join existing tags based on similarity between the tags. Tags may be strings combining one or more words or abbreviations, so similarity may be interpreted as linguistic similarity or semantic similarity. One or more existing tags may be linked based on a criterion for joining tags, and thus to reconfigure existing tags by merging the linked tags. The innovation management system 202 may provide and display a list of similar tags, together with information about their usage and a degree of similarity between the each couple of similar tags. Based on existing similarities between tags, the idea coach 210 may further join similar tags. Joined similar tags may be unified. For example, a leading tag may be selected and used to replace and unify the joined similar tags.

FIG. 2B is a flow diagram illustrating a process 260 for navigation in innovation management system 202 based on existing tags assigned to artifacts, according to one embodiment. A user 265, who may be a system front-end user or a back office user at 270 may navigate between artifacts in the innovation management system 202 based on existing tags. For example, the user 265 may select a particular tag and a set of artifacts (e.g. ideas, campaign, users, etc.) associated with that tag may be presented on a UI of either a front-end application used by a front-end user or of a back office application used by a back-office user. When an additional tag is selected, then the set of artifacts that is displayed contains all artifacts with all of the selected tags. The selected tags may be displayed on the UI. A selected tag may be removed from the selection, which then leads to an adjusted list of artifacts to be displayed.

FIG. 2C is a flow diagram illustrating a process 280 for administering tag assignments to artifacts in an innovation management system 202, according to one embodiment. A campaign administrator 285 may define at 295 a set of tags for a particular campaign. The campaign administrator 285 may be a manager defined for the particular campaign. The campaign administrator 285 may be a back-office user in a role of a campaign administrator in the innovation management system 202, FIG. 2A and FIG. 2B. At 290, the campaign admin 285 may define rules for handling tags for a campaign. For example, specify when two tags are similar enough to be joined or merged.

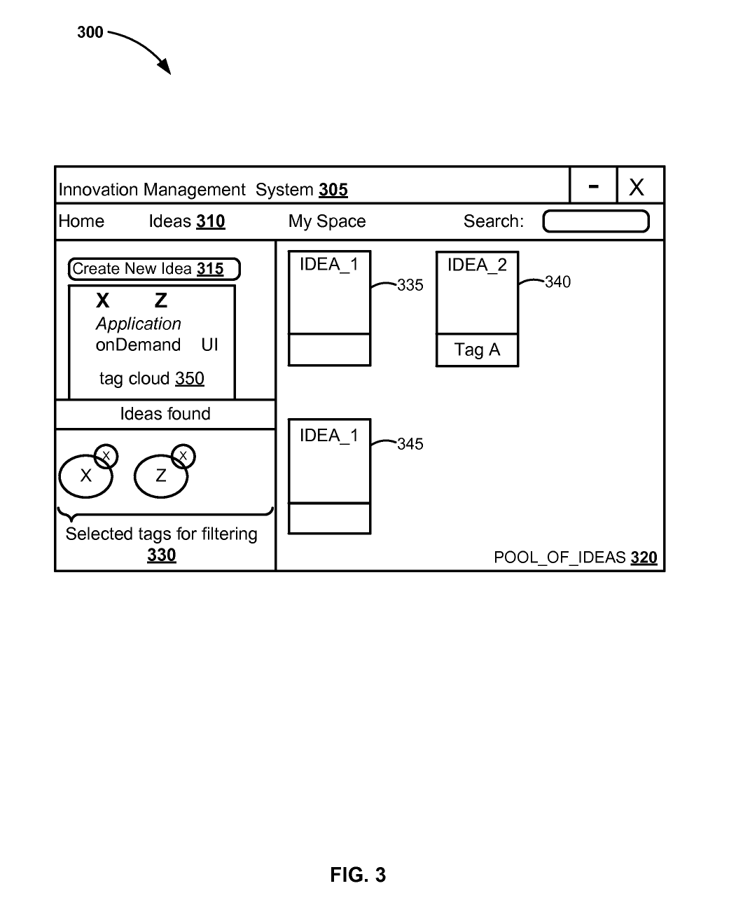

FIG. 3 is a block diagram illustrating an exemplary user interface (UI) 300 for presenting objects that are structured through tags in an innovation management system 305, according to one embodiment. The objects in the innovation management system 305 may be such as the artifacts suggested at FIG. 2A—ideas, campaigns, user, etc. The innovation management system 305 provides the exemplary user interface 300 where objects may be displayed. For example, in Ideas 310 tab, ideas that are stored in the innovation management system 305 may be displayed in a pool_of_ideas 320 display area. A new idea may be created in the innovation management system 305 through an interaction with a UI element—“create new idea” 315. Through the exemplary UI 300, tag-based navigation may be performed. The tag-based navigation may be corresponding to the tag-based navigation 270, FIG. 2B.

In one embodiment, in order to support tag-based navigation, tag clouds may be offered and displayed on the UI 300. A tag cloud 350 is displayed on the UI 300. The tag clouds may render a limited number of tags in different sizes. With a tag cloud “more relevant” tags may be displayed bigger than “less relevant” tags. A relevancy of a tag may be associated with a frequency of usage of the tag and selectiveness of the tag. For example, depending on the task of a user during navigating in the innovation management system 305, the relevance of the tags may depend on different criteria. If the user wants to learn what is going on in a campaign, the tags that are more frequently used are more relevant to the user. If a user wants to search for specific ideas, the tags that are more selective are more relevant to the user. The tag cloud 350 may be defined based on relevancy of tags in the innovation management system 305, which is defined according to frequency of use of the tags and selectiveness of the tags, and a limited number of tags for the tag cloud 350. In the tag cloud 350, the limited number of tags defined is 5. The tags included in the tag cloud 350 are X, Z, Application, onDemand, UI. The tags are displayed with a different size that corresponds to the relevance of the tag, as computed in the innovation management system 305. For example, tags with bigger size are tags that are more relevant according to the innovation management system 305. When navigating through tags in the innovation management system 305, one or more tags may be selected, for example, from the displayed tag cloud 350. The selected tags may be presented in block 330, which includes all tags that are selected for filtering the ideas to be displayed in the pool_of_ideas 320. The ideas that are filtered through the selection of tags 330 are Idea_1 335, Idea_2 340, and Idea_3 345. Idea_2 340 is also assigned with a Tag A. The Tag A may be selected and included into the selected tags for filtering 330. In another embodiment, through a search function provided by the innovation management system 305, ideas may be filtered and displayed in the pool_of_ideas 320. The displayed ideas resulting from the search may be tagged with different tags. In one embodiment, through selecting a tag of an idea displayed in the pool_of_ideas 320, a filter may be created that adjusts the displayed ideas in the pool_of_ideas 320. The display of ideas is adjusted to those that are assigned with the selected tag for filtering. When tag clouds are used for navigation aids, the terms or strings corresponding to the tags are hyperlinked to objects associated with the tag.

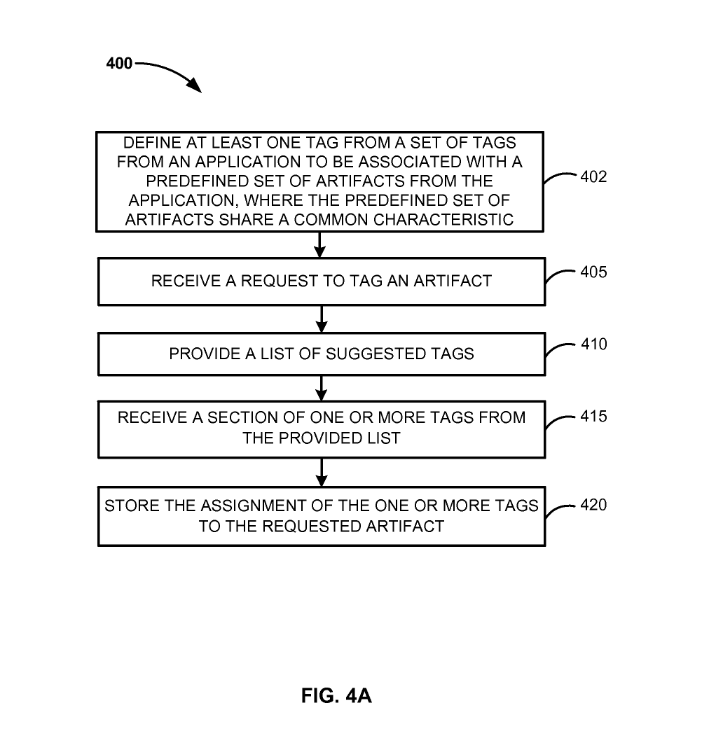

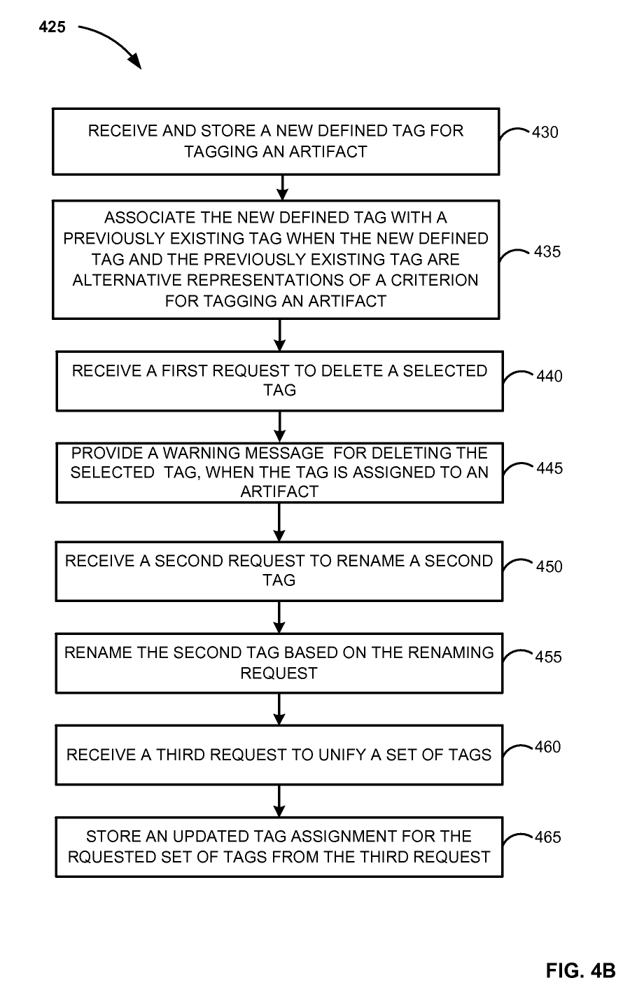

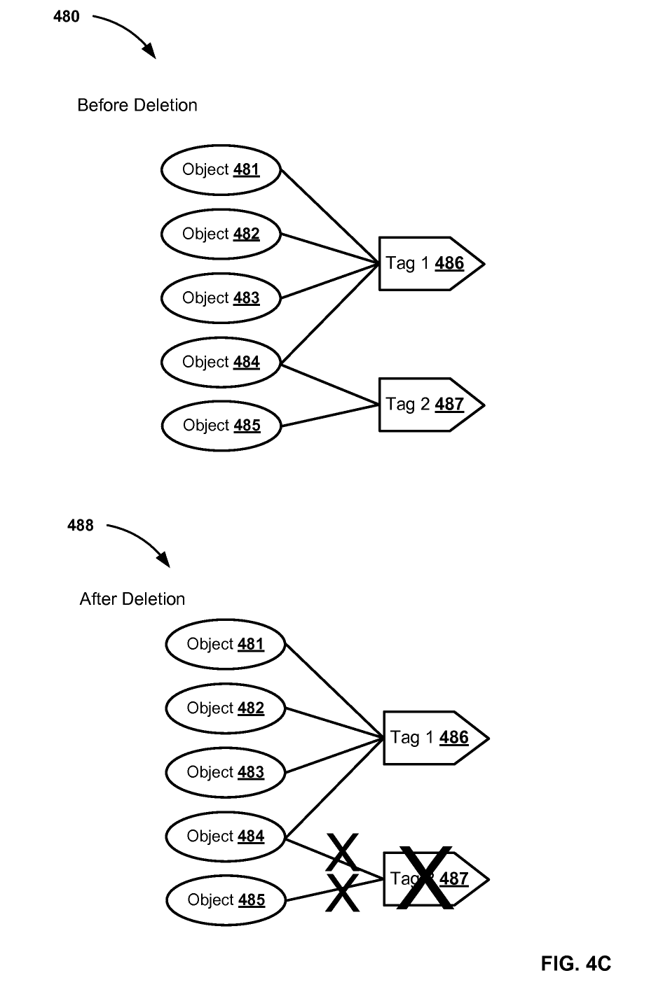

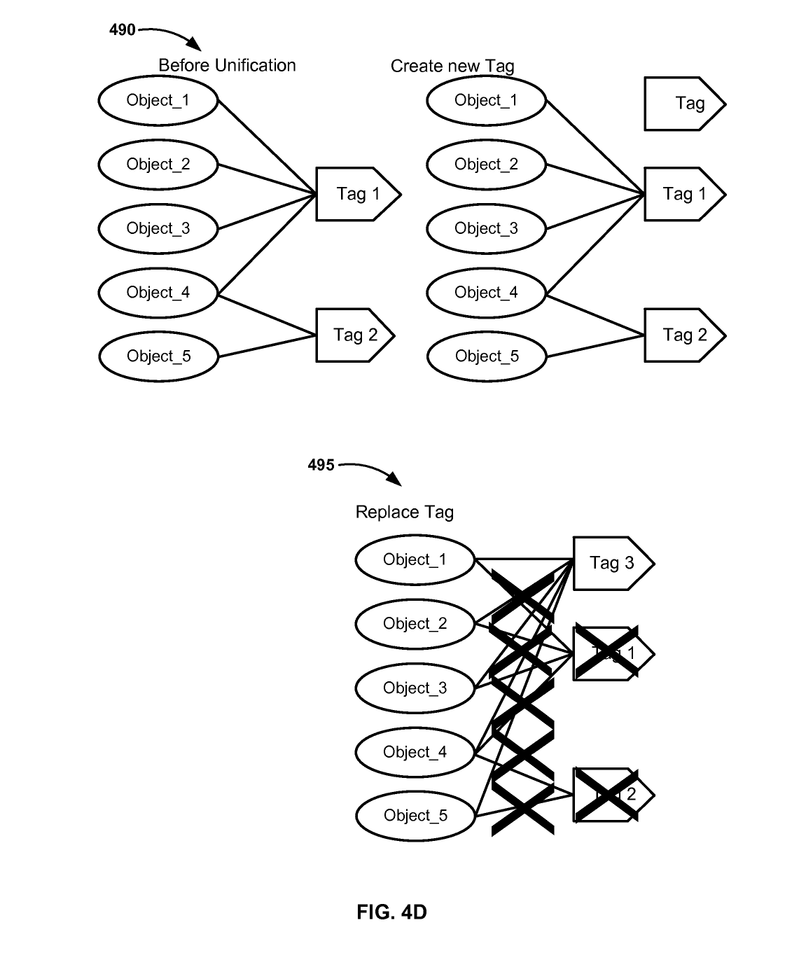

FIG. 4A is a flow diagram illustrating a process 400 for assigning tags to artifacts, according to one embodiment. The artifacts may be objects stored in an application. The application may be such as the innovation management system described at FIG. 2A (202) and FIG. 3 (305). The application maintains artifacts that are assigned with tags. At 402, at least one tag from tags maintained in the application is associated with a predefined set of artifacts from the application. For example, the predefined set of artifacts may share a common characteristic, such as ideas related to a common topic. If the application is an innovation management system, then ideas that are part of one campaign may be an example of a predefined set of artifacts that are associated with a defined tag. If the predefined set of artifacts are related to a sorting algorithm, then a tag, defined for that particular predefined set of artifacts, may be a string comprising both the words “sorting” and algoritms”—“sortingAlgoritms”, or just “sorting”.

At 405, a request is received for assigning a tag to an artifact. With the request, a targeted artifact is determined. At 410, based on the requested artifact for tagging, a list of suggested tags is provided. The list of suggested tags may be a list of all available tags that are existing and associated with other artifacts maintained by the application. In another embodiment, when the requested artifact is part of a predefined group of artifacts, the list of suggested tags may include only the tags that are associated with that predefined group. For example, if the artifact is an idea in an innovation management system, and the idea is part of a campaign, only the tags that are associated with the campaign may be suggested. At 415, a selection of one or more tags is received for assigning to the requested artifact. At 420, the assignment of the one or more tags to the requested artifacts is stored. The tag is added to the requested artifact. By adding the tag, if it does not exist so far in the application that maintains the artifact, the tag is created and stored. The relationship between the artifact and the tag has an explanatory character for the artifact.

FIG. 4B is a flow diagram illustrating a process 425 for maintaining existing tags assigned to artifacts, according to one embodiment. At 430, a new defined tag is received and stored with other maintained tags in an application, for example, through a user interaction. If the tag is defined for an artifact from an innovation management system, such as the innovation management system 202, FIG. 2A, then a front-end user (e.g. idea submitter) or a back office user (idea coach, campaign admin, etc.) may define the tag. An idea submitter knows the idea best and may suggest and define helpful tag assignments.

In one embodiment, a completely free tag assignment may lead to a wide variety of tags, which mean the same or describe a common criterion for tagging. For example, “UI design”, “usability”, “UI improvements”, etc. may be a couple of tags inside an application that are related. With a growing number of tags, there may be a need for tag maintenance functions, provided by the application, for the purpose to maintain a clear set of tags. There may be a function that suggests related tags from the application that may be reviewed and maintained. For example, the suggested tags may be unified, if they comply with a criterion for unification. Further, the suggested tags may be renamed, as they may have some typo mistakes in their definition, or they may not comply with a desired syntax used for defining tags in the application. Therefore, functions such as a delete function, a rename function, a merge function, or a unification function, etc. may be provided to maintain tags assignments to artifacts in the application. Users in different roles may utilize these functions to cleanse the set of tags maintained by the system.

At 435, from the stored tags, determine a previously existing tag that is similar to the stored new defined tag at 430, and associated the new defined tag with the similar tag. The similarity between the two tags may be determined based on a similarity function available through the application, maintaining the artifacts and the tags. Similarity between tags may appear when for example two tags are alternative representations of a criterion for tagging artifacts. Another example, may suggest that similarity between tags appear and may be detected when there is a typographical error in a tag definition, which may lead to the existence of a couple of tags meaning the same but spelled differently. If the application is the innovation management system 202 from FIG. 2A, a first tag assigned to a new defined idea may be “UI”. However, there may be another second idea in the innovation management system 202 that is similar to the new defined idea and is tagged with the tag “User Interface”. Both these tags are alternative representations of the common characteristic that both these ideas share—they are associated with user interface, which may be abbreviated as “UI” (UI stands for user interface). Therefore, the tags “UI” and “user interface” may be associated. If a previously existing tag similar to the new defined tag at 430 is non-existing, then 435 may be omitted.

At 440, a first request to delete a selected tag is received. At 445, if the selected tag is assigned to an artifact, a warning message is provided. For example, the warning message is displayed on the UI of the application maintaining the artifacts and the tags. The selected tag may be deleted and if the tag was assigned to an artifact, the association between the tag and the artifact is also deleted. An exemplary schema for deleting tags is described below in relation to FIG. 4C. At 450, a second request to rename a second tag is received. A tag may be renamed to comply with a certain user preference, or for the reason of correcting a typo error in the strings representing the tag. At 455, the requested second tag is renamed. At 460, a third request to unify a set of tags is received. The third request may be received through a user interaction defining a unification tag to replace each tag from the requested set of tags. The unification tag may be a newly defined tag that is unassigned to an artifact, or may be a tag from the set of tags defined for unification.

In one embodiment, unification may be performed over a list of tags that are determined as similar. Similarity may be detected for cases where typos, etc. lead to tags that are different but mean the same. For example, if an artifact is related fashion, then an exemplary tag may be “fashion”, and one may type “faschion” by mistake, therefore there may be two tags with a similar meaning—fashion and faschion. From the list of similar tags, a user may be able to select tags for unification. The unification may comprise deletion of one or more of the tags included in the list of similar tags and replacing them with one unifying tags. The list of similar tags may be defined through identifying a tag similarity between existing tags. The tag similarity may be determined by means of a trigram index and by means of damerau-levenshtein metric. Before tags are compared with regard to similarity, they may be normalized through converting to lower case and omitting a leading and a trailing space. Two tags are considered potentially similar if they share at least one common trigram after normalization. A trigram may be series of three characters, e.g. “abc”, “ab1”. If they are considered potentially similar, an edit distance between the two tags is computed through the damerau-levenshtein distance metric. The damerau-levenshtein distance is a distance between two strings, i.e., finite sequence of symbols, given by counting the minimum number of operations needed to transform one string into the other, where an operation is defined as an insertion, deletion, or substitution of a single character, or a transposition of two adjacent characters. A character insertion, deletion or substitution is weighted by +1 distance. Transpositions are weighted with +2 distance. For performance reasons the edit distance computation may be limited to edit distance of a certain number. For example, every comparison of two strings with an edit distance greater than 4 may be considered as not similar.

In one embodiment, the application maintaining the tags and artifacts may provide a function to compute a similarity index for all tags. The similarity index may include determination of a trigram for a particular tag and computation of an edit distance between the particular tag and a tag from rest of the tags. Then, if a trigram exists, edit distances may be computed. The function may be called every time a tag changes or a new tag is created. The similarity index function may be triggered for each change of any tag. When computing the similarity index, any index entries existing for a given tag may be removed and replaced by the newly computed similarity index. For example, if an action from a user to a tag is for renaming of the tag, then a redetermination of existence of a trigram of the normalized tag is triggered. Based on the determination, edit distance may be recomputed. The results may be stored in corresponding indices. The function may compute the index entries for all tags at once. For example, two tags—“test” and “west” are evaluated for similarity based on the function described above to compute a similarity index. The following steps may be performed: 1) tags are normalized, which in the current example does not change them, as there are no whitespaces; 2) a trigram is determined—“est”; 3) due to the fact that a trigram exists, an edit distance is computed, which is 1, as the only operation that is performed in order to transform “test” into “west”, is to substitute “t” with “w”, which is defined as distance of 1. If we take a second example, of computing a similarity index between “test” and “what”, then the steps may be as follows: 1) normalization of the tags—they are not changed as there are no whitespaces; 2) a trigram is determined—there is no trigram that is shared by both of the tags, therefore, it may be concluded that these tags are nor similar. However, for the sake of the example, if an edit distance between “test” and “what” is about to be computed, then the edit distance is determined to be 3, as “t” is about to be replaced with “w”, “e” is about to be replaced with “h”, and “s” is about to be replaced with “a”, which all adds up into distance of 3 (1+1+1=3).

Further, existing tags may be grouped into clusters, which define that they are with high correlation. For example, an artifact assigned with a tag A have very often tag B. Tags within a cluster may be subject to suggestion for unification. For example, the third requests at 460 may be a unification request sent for a set of tags that form a tag cluster.

At 465 an updated tag assignment is stored for the requested set of tags for unification at 460. During the unification, the assignments of the set of tags are adjusted according to the received third request. An exemplary schema for unification of a set of tags is described below in relation to FIG. 4D.

FIG. 4C is a block diagram illustrating exemplary schemas for deleting an existing tag assigned to artifacts, according to an embodiment. Object 481, Object 482, Object 483, and Object 484 are assigned with tag_1 486; and Object 484 and Object 485 are assigned with Tag_2 487 as presented on schema 480. A request, for example such as the first request to delete a selected tag (440, FIG. 4b), is received. The request identifies Tag_2 487 to be deleted. Then, after the deletion is performed, the association between tags—Tag_1 486 and Tag_2 487 is stored as defined on schema 488. Tag_2 487 is deleted, and the associations (assignments of tags) between Object 484 and Object 485 and the Tag_2 487 are deleted.

FIG. 4D is a block diagram illustrating exemplary schemas for unifying a set of existing tag assigned to artifacts, according to an embodiment. Object_1, Object_2, Object_3, Object 4, and Object_5 are assigned with Tag1 and Tag2 as defined on schema 490. A new tag—Tag3 is created for the unification as a unification tag. Tag3 replaces Tag1 and Tag2 for the assignments of Tag1 and Tag2 to Objects_1, Object_2, Object_3, Object_4, and Object_5 as presented on schema 495.

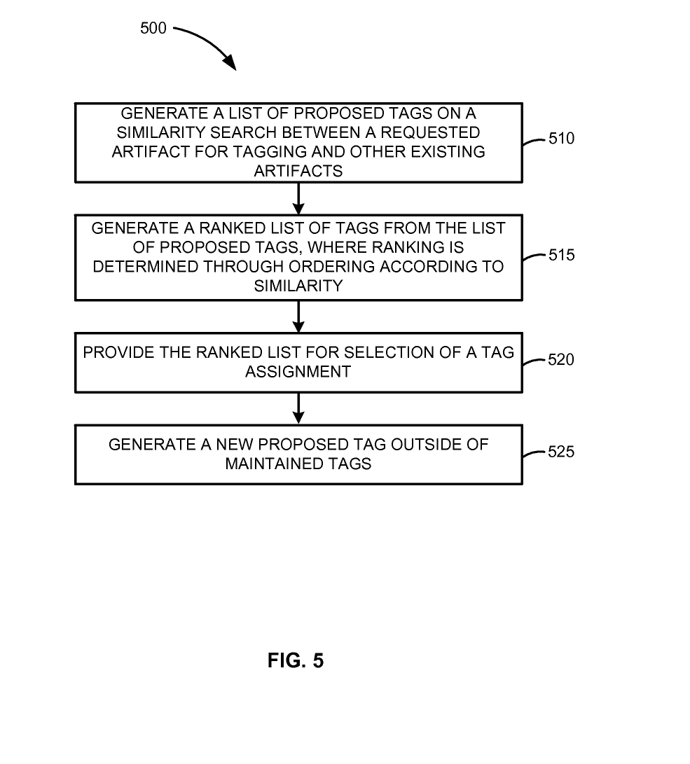

FIG. 5 is a flow diagram illustrating a process 500 for generating a list of suggested tags for assigning to an artifact, according to one embodiment. At 510, a list of proposed tags is generated based on a similarity search between the requested artifact for tagging and other existing artifacts in an application. At 515, based on the generated list of proposed tags, a ranked list of tags is generated where a tag associated with an artifact, which is determined to be of higher similarity to the requested artifact, may come first in the ranked list. At 520, the ranked list of tags is provided for tag assignment. The tag assignment may be performed through an interaction, such as a selection of a tag from the ranked list of tags. At 525, a new proposed tag is generated and provided for assigning to the requested artifact. The new proposed tag is outside of the maintained tags in the application. In one embodiment, the new proposed tag may be defined based on the content of the artifact. For example, the new proposed tag may be defined through a text analysis over description and/or content, and/or title, etc. of the requested artifact.

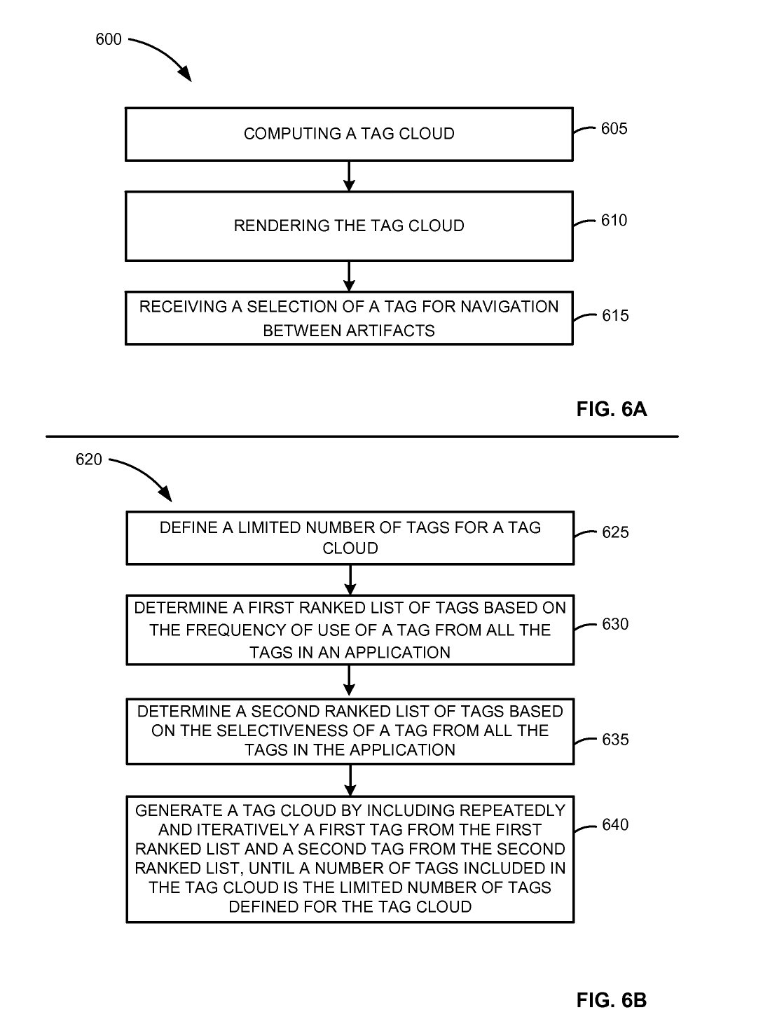

FIG. 6A is a flow diagram illustrating a process 600 for navigation between artifacts through a tag cloud, according to one embodiment. For example, the artifacts and tags assigned to the artifacts may be stored in an application, such as the innovation management system 202, FIG. 2A, or innovation management system 305, FIG. 3. A tag cloud may include a limited number of tags that are determined to be with higher relevancy for the application based on the stored artifacts, and the existing tag assignments. The relevancy of a tag may be computed based on frequency of use of a tag and selectiveness of a tag. Methods for computation of a tag cloud are described in further detail in relation to FIG. 6B below. At 605, a tag cloud is computed. The tag cloud includes a set of tags from the tags defined in the application. At 610, the defined tag cloud is rendered, for example, on a UI of the application. For example, the tag cloud may be rendered such as the tag cloud 350 on the UI of the innovation management system 305, FIG. 3. The rendered tags from the tag cloud are presented with a size that corresponds to a computed relevancy of the tag determined for the application, comprising the artifacts and the tags. Based on the rendered tag cloud, at 615 a selection of a tag from the tag cloud is received. With the selection, a filter to the artifacts to be presented by the application is defined. Only the artifacts that are assigned with the selected tag are displayed. If a next tag is selected from the tag cloud, the displayed artifacts are those of the artifacts that are assigned simultaneously with the firstly selected tag and the second tag.

FIG. 6B is a flow diagram illustrating a process 620 for computing a tag cloud based on existing tags assigned to artifacts in an application, according to one embodiment. The process 620 may be applied for computing the tag cloud at 605, FIG. 6A. The tag cloud may be one that is rendered at step 610, FIG. 6A. At 625, a limited number of tags are defined for a tag cloud that is computed for a particular application. The application comprises artifacts and tags that may be assigned to the artifacts. The limited number of tags may be five, such as the example described on FIG. 3. Depending on the task of a user, the relevance of a tag may depend on different criteria. With the example of an innovation management system as suggested on FIG. 2 an FIG. 3, if a user wants to learn what is going on in a campaign, the tags that are more frequently used are more relevant for the user. If a user wants to search for specific ideas, the tags that are more selective are more relevant to the user. Therefore, when computing the tag cloud, both the frequency of use of a tag and the selectiveness of a tag may be taken into account to compute most relevant tags to be included into the tag cloud. In one embodiment, tag clouds may vary depending on the underlying data related to the existing artifacts, the tags, and the associations between tags and artifacts, which are defined. In addition, current selections made by a user in the application may reflect on the determination of the tag cloud.

At 630, a first ranked list of tags is determined. The first ranked list of tags is determined by a first ordering of tags that exist in the application. The first ordering of the tags is based on the frequency of use of a tag from all of the tags that are being ordered. For example, the frequency of a tag is computed by counting the number of artifacts that are assigned with the tag. At 635, a second ranked list of tags is determined. The second ranked list of tags is defined by a second ordering of the tags that exist in the application. The second ordering of the tags is based on selectiveness of a tag from all of the tags in the application. The selectiveness may be defined by means of a binary entropy function H(p) (function (1)) for a given tag. Selectiveness is computed in the following manner according to function (1), function (2), and function (3):

$$\begin{matrix}H ( Tag ) := H ( {p}_{Tag} ) , where & ( 1 ) \\ H ( p ) := - p {log}_{2} p - ( 1 - p ) {log}_{2} ( 1 - p ) , & ( 2 ) \\ {p}_{Tag} := \frac{number of ideas with Tag}{number of ideas} & ( 3 )\end{matrix}$$

Selectiveness may be defined as information content related to existence (or presence) of a tag assigned to a particular artifact. The binary entropy function is defined as entropy of a Bernoulli trial and is a function of success probability, where the Bernoulli trial is modeled as a random variable that can take on only two values: 0 and 1, which means that either an artifacts is assigned with a tag (success), or there is no tag. The H(p) function is a concave function with symmetry at 0.5. Tags may be sorted based on selectivity through computing the entropy function. If the entropy function is used for sorting, it may be sufficient to compute a substitute function to function H(p) presented with function (2). The substitute function may be a function that shares the same behavior as the entropy function H(p). The substitute function may have a corresponding function values for a set of values of the parameter p compared the entropy function H(p) values for the same set of values for the parameter p. In one embodiment, a substitute function to the entropy function H(p) may be defined through a linear interpolation. Linear interpolation may be applied at values 0, 0.5 and 1. The entropy function H(p), defined with function (2), when computed at value 0.5 is equal to 1 (H(0.5)=1), and the entropy function H(p), when computed at value 0 and value 1 is equal to 0. Therefore, a substitute function Y(p) for function H(p) may be determined through combining a function Y₁, when interpolating at p=0.5 (H(0.5)=1) and with p=0 (H(0)=0), with consecutive equations (4), (5), and (6); and a function Y₂ with equations (7), (8), and (9), when interpolating with p=0.5 (H(0.5)=1) and p=1 (H(1)=0):

$$\begin{matrix}{Y}_{1} = 1 + ( 0 - 1 ) \frac{p - 0.5}{0 - 0.5} & ( 4 ) \\ {Y}_{1} = 1 + \frac{p - 0.5}{0.5} & ( 5 ) \\ {Y}_{1} = 1 + 2 ( p - 0.5 ) & ( 6 ) \\ {Y}_{2} = 1 + ( 0 - 1 ) \frac{p - 0.5}{0 - 0.5} & ( 7 ) \\ {Y}_{2} = 1 - \frac{p - 0.5}{0.5} & ( 8 ) \\ {Y}_{2} = 1 - 2 ( p - 0.5 ) & ( 9 ) \\ Y = 1 - 2 abs ( p - 0.5 ) & ( 10 )\end{matrix}$$

Therefore, based on functions Y₁ and Y₂, the function Y may be defined as the substitute function to the entropy function H(p), when the entropy function is used for sorting tags based on selectiveness of tags, that is defined by the entropy function H(p). The function Y is defined as in function (10). Function Y is sufficient and precise enough to be used for the purpose of sorting selectiveness of tags.

Further, for the sake of sorting, the function H(p), as defined above at function (2), may be also substituted with function Z(p), which may look as follows:

Z:=1−4(p−0.5)² (11)

Function Z(p) as defined at (11) may be used for a better proximity to the results that may be computed with the entropy function H(p). However, for the sorting purposes of determining relative selectiveness of tags in the application storing tags assigned to artifacts, function Y(p) is sufficient enough and requires less computing resources. Therefore, it is cheaper to compute Y(p), compared to computing H(p).

At 640, the tag cloud is generated by including repeatedly and iteratively a first tag from the first ranked list (generated at 630), and a second tag from the second ranked list (generated at 635). The inclusion of tags from both lists is performed until a number of tags included in the tag cloud reaches the limited number of tags as defined for the tag cloud at 625. When applying the approach for computing a tag cloud as described in FIG. 6B, two ranked lists of tags are defined, a list ranked by frequency and a list ranked by selectivity. Each artifact may appear in each list exactly once. A tag cloud of 2n entries is defined through picking at least n tags from each of the lists and through ensuring that there are no duplicate tags selected and entered in the tag cloud. If the tag cloud is formed of 2n entries, then the limited number of tags is defined to be 2n entries, and n of the entries may be from the first ranked list based on sorting according to frequency of use, and the second n entries may be from the second ranked list based sorting according to selectiveness of tags. In order to generate the result list of tags that form the tag cloud, the two ranked lists may be combined as described in Table 1 below.

TABLE 1

| | |
|---|---|
| 1. | Determine a list, named LF, of tags ranked by frequency (most |
| | frequent first) |
| 2. | Determine a list, named LS, of tags ranked by selectivity (most |
| | selective first) |
| 3. | Create a Result list for storing tags that are selected for forming |
| | a tag cloud, where the Result list is empty. |
| 4. | While the Result list has less than 2n tags and there are tags |
| | remaining in the LF and the LS: |

| | |
|---|---|
| a. | If there are tags remaining in the LF |

| i. | Pick a first tag of remainder of the list |
|---|---|
| | LF and remove it from the LF |
| ii. | If the picked tag is not yet in the Result list, |
| | then append it to the Result list |
| iii. | Else (if the picked tag is already in the Result |

list), skip the picked first tag

| | |
|---|---|
| b. | If there are tags remaining in the LS |

| i. | Pick a first tag of remainder of the list |
|---|---|
| | LS and remove it from LS |
| ii. | If the picked tag is not yet in the Result list, |
| | append it to the Result list |
| iii. | Else, skip the picked first tag |

For example, if we have tags T1, T2, T3, T4, and T5 with rank lists: LF=[T1, T2, T3, T4, T5] and LS=[T2, T1, T5, T3, T4], where LF is the first ranked list as described in relation to 630, FIG. 6B and Table 1, and LS the second ranked list as described on 635, FIG. 6B and Table 1. If the limited number of tags defined for the tag cloud is 4 tags, then the algorithm suggested above at Table 1, defined computations described in Table 2 below, which are related to step 3 from Table 1.

TABLE 2

3a: result = [T1]
3b: result = [T1, T2]
3a: skip T2 (as it is already in in result) → result list: = [T1, T2]
3b: skip T1 as it is already in in result → result list: = [T1, T2]
3a: result list: = [T1, T2, T3]
3b: result list: = [T1, T2, T3, T5]

The process of step 3 terminates and the result list comprises the desired number of tags. Once the result list is computed, the tag cloud may be rendered by a layout algorithm.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

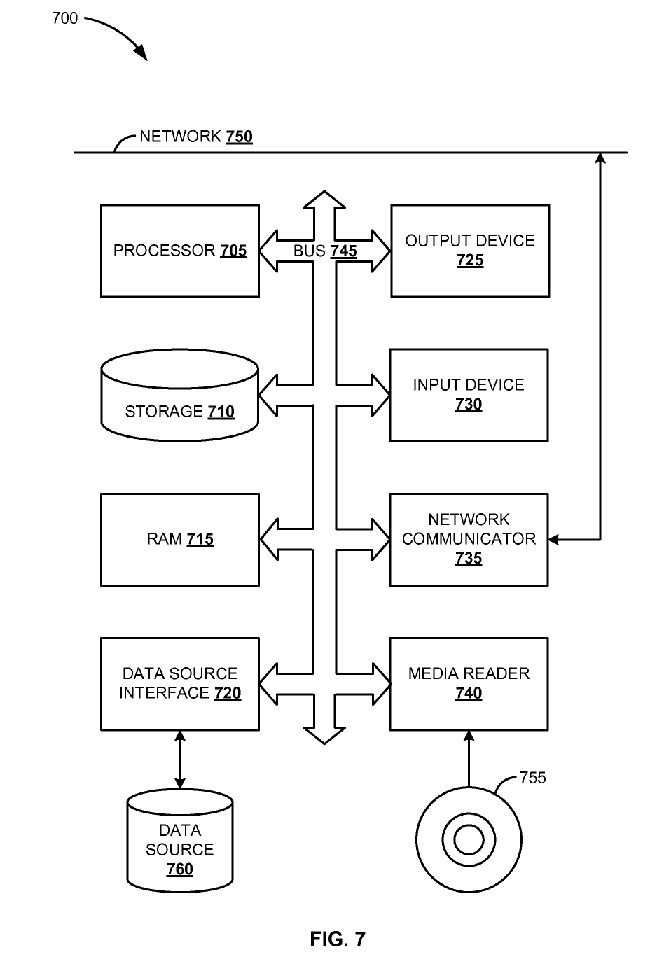

FIG. 7 is a block diagram of an exemplary computer system 700. The computer system 700 includes a processor 705 that executes software instructions or code stored on a computer readable storage medium 755 to perform the above-illustrated methods. The processor 705 can include a plurality of cores. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. According to some embodiments, such as some in-memory computing system embodiments, the RAM 715 can have sufficient storage capacity to store much of the data required for processing in the RAM 715 instead of in the storage 710. In some embodiments, all of the data required for processing may be stored in the RAM 715. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to maintain tags assigned to artifacts, the method comprising:
receiving a request to tag an artifact from one or more artifacts;
providing a list of suggested tags for tagging the artifact, wherein the list of suggested tags comprises an existing tag from a maintained set of tags for assigning and a new proposed tag;
receiving a selection of one or more tags to be assigned to the artifact from the list of suggested tags;
storing the one or more tags assigned to the artifact;
determining a similarity between at least two tags from the maintained set of tags to provide a list of similar tags, wherein the similarity is determined based on existence of a trigram in the at least two tags after normalization of tags and based on edit distance between each two tags from the at least two tags, wherein the normalization of tags is a conversion of a tag into a lower case string without leading and trailing spaces, and wherein the edit distance defines a number of operations to perform when transforming one tag into another;
updating and cleansing the maintained set of tags through unifying a plurality of tags based on the provided list of similar tags; and
computing a tag cloud to allow navigation between the one or more artifacts based on relevance of a tag from the updated and cleansed set of tags, wherein the relevance of the tag is associated with frequency of use and selectiveness of the tag.

2. The method of claim 1, wherein providing the list of suggested tags further comprises:
generating a list of proposed tags for assigning to the artifact, wherein the list of proposed tags is generated based on the maintained set of tags and existing tag assignments for the one or more artifacts;
generating and providing a ranked list of proposed tags through ordering the list of proposed tags according to similarity between the artifact and rest of artifacts assigned with at least one tag from the list of proposed tags;
generating the new proposed tag outside of the maintained set of tags to be assigned to the artifact based on analysis of the artifact; and
wherein the one or more artifacts, the updated set of tags, and assignments of tags to artifacts are stored in an innovation management system.

3. The method of claim 2, further comprising:
associating a first tag from the maintained set of tags to a second tag from the maintained set of tags in the innovation management system, when the first tag and the second tag are alternative representations of a criterion for tagging in the innovation management system.

4. The method of claim 2, wherein the list of proposed tags is generated based on a similarity search between the artifact requested for tagging and the rest of artifacts, and wherein when the artifact is part of a predefined set of artifacts, the list of proposed tags further includes a tag from a set of tags associated with the predefined set of artifacts.

5. The method of claim 4, further comprising:
defining at least one tag from the maintained set of tags to be associated with the predefined set of artifacts from the one or more artifacts, wherein the predefined set of artifacts share a common characteristic.

6. The method of claim 2, further comprising:
receiving and storing a new defined tag to characterize the artifact through a user interaction with the innovation management system.

7. The method of claim 1, wherein computing the tag cloud further comprises:
defining a limited number of tags for the tag cloud;
determining a first ranked list of tags from the maintained set of tags based on the frequency of use of a tag from the maintained set of tags;
determining a second ranked list of tags from the maintained set of tags based on the selectiveness of a tag from the maintained set of tags; and
generating the tag cloud by including repeatedly a first tag from the first ranked list of tags and a second tag from the second ranked list until number of included tags is the defined limited number of tags, wherein when the first tag and the second tag are equal the second tag is omitted to include in the tag cloud.

8. The method of claim 7, further comprising:
rendering the tag cloud by displaying a tag from the tag cloud on a user interface with a size corresponding to the relevance of the tag.

9. The method of claim 1, further comprising:
receiving a request to rename, delete, or creating a tag; and
providing a warning message for deleting a tag, when an artifact is assigned to the deleted tag.

10. The method of claim 1, further comprising:
receiving an interaction to replace an existing tag assignment to one or more requested artifacts with a replacing tag; and
storing an update in tag assignments for the existing tag assigned to the one or more requested artifacts and for the replacing tag.

11. A computer system to maintain tags assigned to artifacts, the system comprising:
a processor; and
a memory in association with the processor storing instructions to:
receive a request to tag an artifact from one or more artifacts;
provide a list of suggested tags for tagging the artifact, wherein the list of suggested tags comprises an existing tag from a maintained set of tags for assigning and a new proposed tag;
receive a selection of one or more tags to be assigned to the artifact from the list of suggested tags;
store the one or more tags assigned to the artifact;
determine a similarity between at least two tags from the maintained set of tags to provide a list of similar tags, wherein the similarity is determined based on an existence of a trigram in the at least two tags after normalization of tags and based on edit distance between each two tags from the at least two tags, wherein the normalization of tags is a conversion of a tag into a lower case string without leading and trailing spaces, and wherein the edit distance defines a number of operations to perform when transforming one tag into another;
update and cleanse the maintained set of tags through unifying a plurality of tags based on the provided list of similar tags;
compute a tag cloud to allow navigation between the one or more artifacts based on relevance of a tag from the updated and cleansed set of tags, wherein the relevance of the tag is associated with frequency of use and selectiveness of the tag; and
render the tag cloud by displaying a tag from the tag cloud on a user interface with a size corresponding to the relevance of the tag.

12. The system of claim 11, wherein the instructions to provide the list of suggested tags further comprises instructions to:
provide the list of suggested tags further comprises:
generate a list of proposed tags for assigning to the artifact, wherein the list of proposed tags is generated based on the maintained set of tags and existing tag assignments for the one or more artifacts;
generate and providing a ranked list of proposed tags through ordering the list of proposed tags according to similarity between the artifact and rest of artifacts assigned with at least one tag from the list of proposed tags;
generate the new proposed tag outside of the maintained set of tags to be assigned to the artifact based on analysis of the artifact; and
wherein the one or more artifacts, the updated set of tags, and assignments of tags to artifacts are stored in an innovation management system.

13. The system of claim 12, wherein the list of proposed tags is generated based on a similarity search between the artifact requested for tagging and the rest of artifacts, and wherein when the artifact is part of a predefined set of artifacts, the list of proposed tags further includes a tag from a set of tags associated with the predefined set of artifacts.

14. The system of claim 11, further comprising instructions to:
receive and store a new defined tag to characterize the artifact through a user interaction.

15. The system of claim 11, wherein the instructions to compute the tag cloud further include instructions to:
define a limited number of tags for the tag cloud;
determine a first ranked list of tags from the maintained set of tags based on the frequency of use of a tag from the maintained set of tags;
determine a second ranked list of tags from the maintained set of tags based on the selectiveness of a tag from the maintained set of tags; and
generate the tag cloud by including repeatedly a first tag from the first ranked list of tags and a second tag from the second ranked list until number of included tags is the defined limited number of tags, wherein when the first tag and the second tag are equal the second tag is omitted to include in the tag cloud.

16. A non-transitory computer-readable medium storing instructions to maintain tags assigned to artifacts, which when executed cause a computer system to:
receive a request to tag an artifact from one or more artifacts;
provide a list of suggested tags for tagging the artifact, wherein the list of suggested tags comprises an existing tag from a maintained set of tags for assigning and a new proposed tag;
receive a selection of one or more tags to be assigned to the artifact from the list of suggested tags;
store the one or more tags assigned to the artifact;
determine a similarity between at least two tags from the maintained set of tags to provide a list of similar tags, wherein the similarity is determined based on an existence of a trigram in the at least two tags after normalization of tags and based on edit distance between each two tags from the at least two tags, wherein the normalization of tags is a conversion of a tag into a lower case string without leading and trailing spaces, and wherein the edit distance defines a number of operations to perform when transforming one tag into another;
update and cleanse the maintained set of tags through unifying a plurality of tags based on the provided list of similar tags;
compute a tag cloud to allow navigation between the one or more artifacts based on relevance of a tag from the updated and cleansed set of tags, wherein the relevance of the tag is associated with frequency of use and selectiveness of the tag;
render the tag cloud by displaying a tag from the tag cloud on a user interface with a size corresponding to the relevance of the tag; and
receive a selection of a tag from the tag cloud for navigating to a filtered set of displayed artifacts on a user interface, wherein an artifact from the filtered set of displayed artifacts is assigned with the selected tag from the tag cloud.

17. The computer-readable medium of claim 16, wherein the instructions to provide the list of suggested tags further comprise instructions, which when executed by a computer, cause the computer to:
provide the list of suggested tags further comprises:
generate a list of proposed tags for assigning to the artifact, wherein the list of proposed tags is generated based on the maintained set of tags and existing tag assignments for the one or more artifacts;
generate and providing a ranked list of proposed tags through ordering the list of proposed tags according to similarity between the artifact and rest of artifacts assigned with at least one tag from the list of proposed tags;
generate the new proposed tag outside of the maintained set of tags to be assigned to the artifact based on analysis of the artifact; and
wherein the one or more artifacts, the updated set of tags, and assignments of tags to artifacts are stored in an innovation management system.

18. The computer-readable medium of claim 17, wherein the list of proposed tags is generated based on a similarity search between the artifact requested for tagging and the rest of artifacts, and wherein when the artifact is part of a predefined set of artifacts, the list of proposed tags further includes a tag from a set of tags associated with the predefined set of artifacts.

19. The computer readable medium of claim 16, further comprising instructions, which when executed by a computer, cause the computer to:
receive and store a new defined tag to characterize the artifact through a user interaction.

20. The computer-readable medium of claim 16, wherein the instructions to compute the tag cloud further comprise instructions, which when executed by a computer, cause the computer to:
define a limited number of tags for the tag cloud;
determine a first ranked list of tags from the maintained set of tags based on the frequency of use of a tag from the maintained set of tags;
determine a second ranked list of tags from the maintained set of tags based on the selectiveness of a tag from the maintained set of tags; and
generate the tag cloud by including repeatedly a first tag from the first ranked list of tags and a second tag from the second ranked list until number of included tags is the defined limited number of tags, wherein when the first tag and the second tag are equal the second tag is omitted to include in the tag cloud.
